(19) United States
(12) Patent Application Publication
(10) Pub. No.: US 2024/0297555 A1
(43) Pub. Date: Sep. 5, 2024

(54) ELECTRICAL MACHINE ARRANGEMENT

(71) Applicant: VOLVO TRUCK CORPORATION, Göteborg (SE)

(72) Inventors: Rasmus ANDERSSON, Hisings Backa (SE); John Lord, Olofstorp (SE)

(73) Assignee: VOLVO TRUCK CORPORATION, Göteborg (SE)

(21) Appl. No.: 18/593,426

(22) Filed: Mar. 1, 2024

(30) Foreign Application Priority Data
Mar. 2, 2023 (EP) 23159557.0

(51) Int. Cl. H02K 9/193; H02K 1/32

(52) U.S. Cl. CPC H02K 9/193; H02K 1/32

(57) ABSTRACT

An electrical machine arrangement is provided. The arrangement includes an electrical machine having a rotor, a stator, and a housing enclosing said rotor and stator, and an oil cooling system connected to the electrical machine and configured to control the oil flow to and from a first axial side of the electrical machine, wherein the rotor comprises at least one channel for pumping oil from the first axial side of the electrical machine to a second axial side of the electrical machine.

### TECHNICAL FIELD

The disclosure relates generally to electrical machine arrangements and applications thereof. In particular aspects, the disclosure relates to an electrical machine and an oil cooling system. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Modern vehicles may be provided with electrical machines. One particular use of electric machines in vehicles is for traction purpose, i.e. the electrical machines are arranged as part of the drive train to perform the desired propulsion of the vehicle. These electrical machines are connected to one or more battery arrangements which provide the electrical machines with the required electrical power.

Electrical machines can also be used to provide retardation of the vehicle, changing the operational mode of the electrical machine from propulsion mode to regeneration mode. In such case the regeneration of electrical power will cause a retarding effect on the vehicle.

However, braking of the electric vehicle using the electrical machine can only be performed as long as the associated battery arrangement is capable of receiving the regenerated electrical power. If the battery arrangement is fully (or close to fully) charged, braking can no longer be achieved by means of the electrical machine.

Based on this, there is a need for improved solutions enabling the electrical machine of a vehicle to brake the vehicle even if the associated battery arrangement is not capable of receiving the generated electrical power.

### SUMMARY

According to first aspect of the disclosure, an electrical machine arrangement is provided. The electrical machine arrangement comprises an electrical machine having a rotor, a stator, and a housing enclosing said rotor and stator, and an oil cooling system connected to the electrical machine and configured to control the oil flow to and from a first axial side of the electrical machine. The rotor comprises at least one channel for pumping oil from the first axial side of the electrical machine to a second axial side of the electrical machine. A technical benefit may include the creating of pump losses in the electrical machine, causing a braking effect.

Optionally in some examples, including in at least one preferred example, the oil cooling system is configured to control a retarding effect of the electrical machine by control of the oil flow to and from a first axial side of the electrical machine.

In some examples, including in at least one preferred example, optionally the oil cooling system comprises a feeder pump. A technical benefit may include that a low complex solution is provided which allows efficient control of the amount of cooling oil inside the electrical machine, and hence controlling of the pumping effect.

In some examples, including in at least one preferred example, optionally the feeder pump is arranged remote from the electrical machine. A technical benefit may include minimum redesign of the electrical machine,

In some examples, including in at least one preferred example, the oil cooling system further comprises a sump and wherein the feeder pump is configured to pump oil from said sump. A technical benefit may include increased braking capacity, since the sump may hold a larger volume of oil. A further technical benefit may include increased cooling capacity, as heat can be dissipated more efficiently.

In some examples, including in at least one preferred example, the oil cooling system further comprises an outlet valve configured to control the oil flow out from the first axial side of the electrical machine. A technical benefit may include that a low complex solution is provided which allows efficient control of the amount of cooling oil inside the electrical machine, and hence controlling of the pumping effect.

In some examples, including in at least one preferred example, the oil cooling system further comprises a control unit configured to control the operation of the feeder pump and/or the outlet valve. A technical benefit may include that a high performance solution is provided which allows improved and more advanced control of the amount of cooling oil inside the electrical machine, and hence controlling of the pumping effect.

In some examples, including in at least one preferred example, the electrical machine further comprises an oil return channel arranged in the radial space formed between the rotor and the stator. A technical benefit may include improved braking capacity using a minimum redesign, as the oil return flow will cause a retardation effect of the rotor.

In some examples, including in at least one preferred example, the rotor comprises a plurality of channels for pumping oil from the first axial side of the electrical machine to a second axial side of the electrical machine. A technical benefit may include increased braking capacity as more oil will be allowed to be pumped through the electrical machine.

In some examples, including in at least one preferred example, the plurality of channels are distributed at an equal angular space around the rotor. A technical benefit may include improved stability during operation, as the pumping channels are symmetrically arranged at the rotor.

In some examples, including in at least one preferred example, the at least one channel is arranged at an outer circumference of said rotor. A technical benefit may include simplified manufacturing of the rotor.

In some examples, including in at least one preferred example, the at least one channel is embedded in the rotor and arranged radially inside the maximum rotor radius. A technical benefit may include a more robust manufacturing, as the outer circumference of the rotor will be left intact.

In some examples, including in at least one preferred example, the at least one channel extends axially along the entire rotor from the first axial side of the electrical machine to a second axial side of the electrical machine. A technical benefit may include increased pumping capacity, as the full length of the rotor is utilized.

In some examples, including in at least one preferred example, the at least one channel extends along a constant radius. A technical benefit may include a more simple manufacturing, since the channels are arranged at the same radius of the rotor.

In some examples, including in at least one preferred example, the at least one channel extends from an inner radius at the first axial side of the electrical machine to an outer radius at the second axial side of the electrical machine. A technical benefit may include improved pumping capability, thereby causing improved braking action, since the oil will be subject to centrifugal forces during rotation of the rotor thereby pressing the oil from one side of the rotor to the opposite side of the rotor.

In some examples, including in at least one preferred example, the at least one channel extends at a constant circumferential angle. A technical benefit may include less complex manufacturing, since the at least one channel will exhibit a straight shape.

In some examples, including in at least one preferred example, the at least one channel extends at a varying circumferential angle. A technical benefit may include a higher pumping capability, and thereby increased pumping capability, as twisted channels may transport more oil.

In some examples, including in at least one preferred example, the rotor is provided with an axial flow pump arranged at the first axial side of the electrical machine. A technical benefit may include improved braking capability, as an axial flow pump can push more oil through the rotor.

In some examples, including in at least one preferred example, the oil cooling system comprises a feeder pump, a sump, an outlet valve, and a control unit. The feeder pump is arranged remote from the electrical machine and configured to pump oil from the sump, wherein the outlet valve is configured to control the oil flow out from the first axial side of the electrical machine, and wherein the control unit is configured to control the operation of the feeder pump and/or the outlet valve. The electrical machine further comprises an oil return channel arranged in the radial space formed between the rotor and the stator. The rotor comprises a plurality of channels for pumping oil from the first axial side of the electrical machine to a second axial side of the electrical machine. The plurality of channels are distributed at an equal angular space around the rotor, wherein the plurality of channels are arranged at an outer circumference of the rotor or embedded in the rotor and arranged radially inside the maximum rotor radius. The plurality of channels extend axially along the entire rotor from the first axial side of the electrical machine to the second axial side of the electrical machine. The plurality of channels extend at a constant radius or from an inner radius at the first axial side of the electrical machine to an outer radius at the second axial side of the electrical machine. Each of the plurality of channels extends at a constant circumferential angle or at a varying circumferential angle, and the rotor is provided with an axial flow pump arranged at the first axial side of the electrical machine.

According to a second aspect of the disclosure, a vehicle is provided comprising the electrical machine arrangement according to the first aspect. The second aspect may seek to improve driving performance of vehicle by utilizing an electrical machine arrangement.

According to a third aspect of the disclosure, a method for cooling an electrical machine is provided. The method comprises: feeding cooling oil to a first axial side of the electrical machine, pumping the cooling oil from the first axial side of the electrical machine to a second axial side of the electrical machine through at least one channel extending along the rotor, and controlling the amount of cooling oil at the first axial side in order to control a retarding effect of the electrical machine.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary side view of a vehicle according to an example.

FIG. 2 is an exemplary cross-sectional view of an electrical machine arrangement according to an example.

FIG. 3 is an exemplary cross-sectional view of an electrical machine arrangement according to a further example.

FIG. 4 is an exemplary cross-sectional view of an electrical machine arrangement according to one example.

FIG. 5A is an exemplary cross-sectional view of a rotor forming part of an electrical machine arrangement according to an example.

FIG. 5B is an exemplary cross-sectional view of a rotor forming part of an electrical machine arrangement according to an example.

FIG. 5C is an exemplary side view of a rotor forming part of an electrical machine arrangement according to a further example.

FIG. 6 is another exemplary view of an electrical machine arrangement according to an example.

FIG. 7 is an exemplary schematic view of a method for cooling an electrical machine according to an example.

### DETAILED DESCRIPTION

The detailed description set forth below provides information and examples of the disclosed technology with sufficient detail to enable those skilled in the art to practice the disclosure.

Details of an electrical machine arrangement will in the following be described. The electrical machine arrangement according to the present disclosure aims to add a braking functionality to the electrical machine by utilizing the oil already provided to cool down the electrical machine during operation. By implementing the electrical machine arrangement in a vehicle, a braking force can be applied to the vehicle by means of the electrical machine even if regeneration of electrical power is not available due to the associated energy storage system, or battery arrangement is fully, or almost fully, charged.

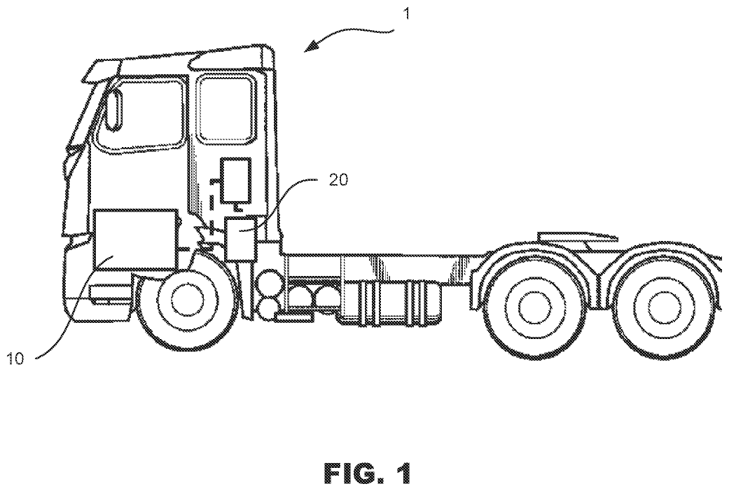

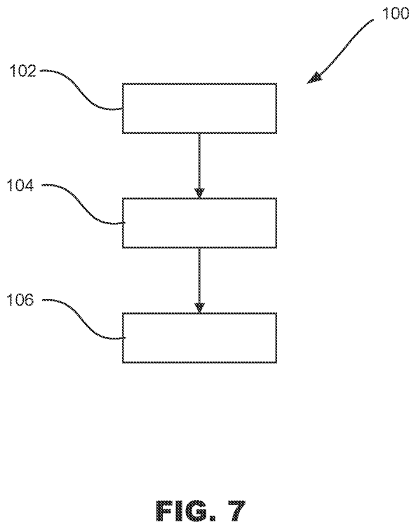

With reference to FIG. 1, a vehicle 1, here embodied as a heavy duty truck 1, is disclosed for which an electrical machine arrangement 10 and a method 100 (see FIG. 7) for cooling an electrical machine of the electrical machine arrangement 100 are advantageous. However, the electrical machine arrangement 10 and/or the method 100 may as well be implemented in other types of applications, in particular in other types of vehicles such as a busses, light-weight trucks, passenger cars, marine applications, construction equipment, etc.

The vehicle 1 is preferably an electric vehicle, such as a full electric vehicle or a hybrid vehicle, comprising at least one electrical machine arrangement 10. Typically the vehicle 1 also comprises an energy storage system 20 comprising energy storage or energy transformation devices, typically batteries or fuel cells. The energy storage system 20 is arranged and configured to power the electrical machine arrangement 10.

The vehicle 1 typically further comprises other parts of a powertrain such as a transmission, drive shafts, and wheels (not shown in details in FIG. 1).

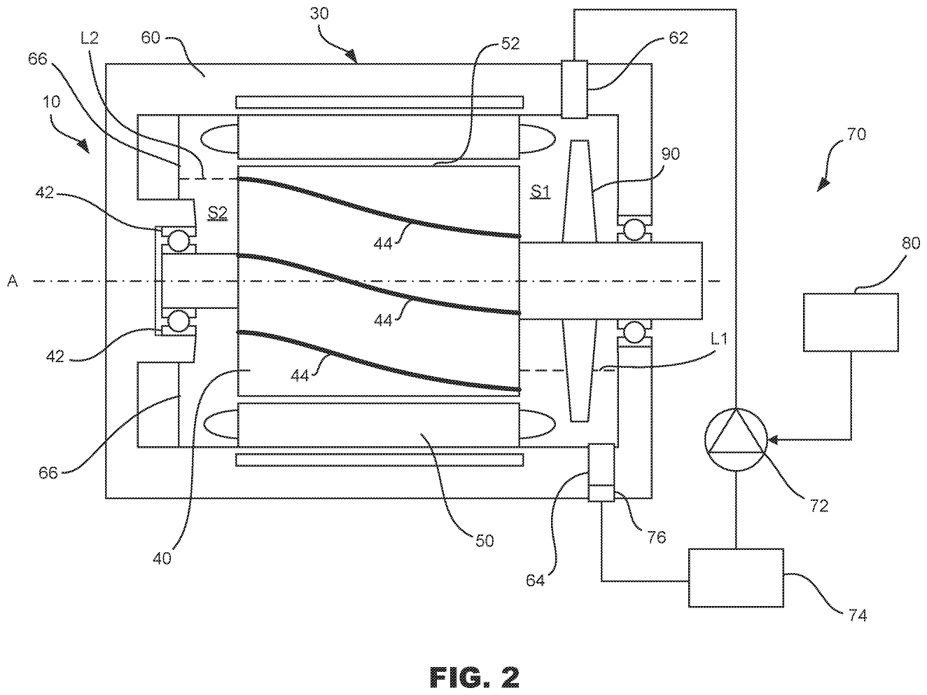

An example of an electrical machine arrangement 10 is shown in FIG. 2. The electrical machine arrangement 10 comprises an electrical machine 30. The electrical machine 30 has a rotor 40, a stator 50, and a housing 60. The rotor 40 is rotatably supported by the housing 60 e.g. by means of one or more bearings 42, allowing the rotor 40 to rotate around rotational axis A. The stator 50 is also enclosed by the housing 60 and arranged radially outside of the rotor 40.

The electrical machine arrangement 10 further comprises an oil cooling system 70. The oil cooling system 70 is configured to provide the electrical machine 30 with cooling oil, thereby preventing the electrical machine 30 from overheating during operation. The oil cooling system 70 comprises an oil feeder pump 72 pumping oil from an oil sump 74. Oil is entering the electrical machine 30 through an inlet port 62 arranged at the housing 60, and oil is exiting the electrical machine 30 through an oil outlet port 64 also arranged at the housing 60 but spaced apart from the oil inlet port 62. Preferably, the oil inlet port 62 is arranged at an upper part of the housing 60 while the oil outlet port 64 is arranged at a bottom part of the housing 60 such that gravity will cause a flow of oil from the oil inlet port 62 to the oil outlet port 64.

The oil exiting the electrical machine 30 will flow from the oil outlet port 64 to the sump 74. In the shown example the oil outlet port 64 comprises an outlet valve 76. The oil outlet valve 76 may in other examples be arranged remote from the oil outlet port 64 but in the oil flow path from the oil outlet port 64 to the sump 74.

The oil inlet port 62 and the oil outlet port 64 are arranged on the same axial side of the electrical machine 30, and in particular on the same first axial side S1 of the rotor 40. Hence, when the feeder pump 72 is running oil will be pumped from the sump 74 into the housing 60 on a first axial side S1 of the rotor 40, and fill this first axial side S1 of the rotor 40 up to an oil level L1. The amount of oil at the first axial side S1 of the rotor 40 will be dependent on the pump rate of the feeder pump 72, as well as on the amount of oil exiting through the oil outlet port 64.

In order to effectively control the amount of oil at the first axial side S1 of the rotor 40, the oil cooling system 70 comprises a control unit 80. The control unit 80 is preferably in communication with the feeder pump 72 as well as with the outlet valve 76 and configured to issue control signals to these components in order to control their respective operation in real time.

In order to provide for the desired braking effect the rotor 40 comprises one or more channels 44. In the shown example, the rotor 40 is provided with a plurality of channels 44 evenly distributed around the rotor 40. In some examples the rotor 40 comprises a plurality of channels 44 arranged non-evenly around the rotor 40. The channels 44 extend along the rotor 40 from the first axial side S1 to the opposite axial side S2. Each channel 44 is configured to guide oil from the first axial side S1 to the opposite axial side S2.

When oil is flowing through the channels 44 a pumping action will be obtained, causing a braking action to the electrical machine 30. In the shown example, an axial flow pump 90 is provided in order to enhance the pumping effect. The axial flow pump 90 is in this example shown as an impeller, arranged on the rotor 40 at the first axial side S1. When the rotor 40 is spinning the impeller will throw oil from the first axial side S1 towards the opposite axial side S2, thereby causing a forced oil flow through the channels 44. Preferably, the axial flow pump 90 is designed to direct the flow of oil towards the center of the rotor 40 rather than spraying the oil radially outwards.

It should however be appreciated that the pumping effect may be achieved also without the provision of an axial flow pump 90, as the increase of oil at the first axial side S1 will cause the oil to flow through the channel(s) 44 to the second, opposite axial side S2.

The oil exiting the channels 44 will fill up the opposite axial side S2 to a level L2. The opposite axial side S2 may be provided with a partition wall 66 extending inside the housing 60 in order to delimit the volume at the opposite axial side S2 of the rotor 40.

As the oil is filling up the opposite axial side S2 of the rotor 40, a return oil channel 52 arranged in the radial space between the rotor 40 and the stator 50 will allow oil to flow back to the first axial side S1 of the rotor 40. This return flow will create a further drag effect on the rotor 40, thereby adding braking effect to the electrical machine arrangement 10.

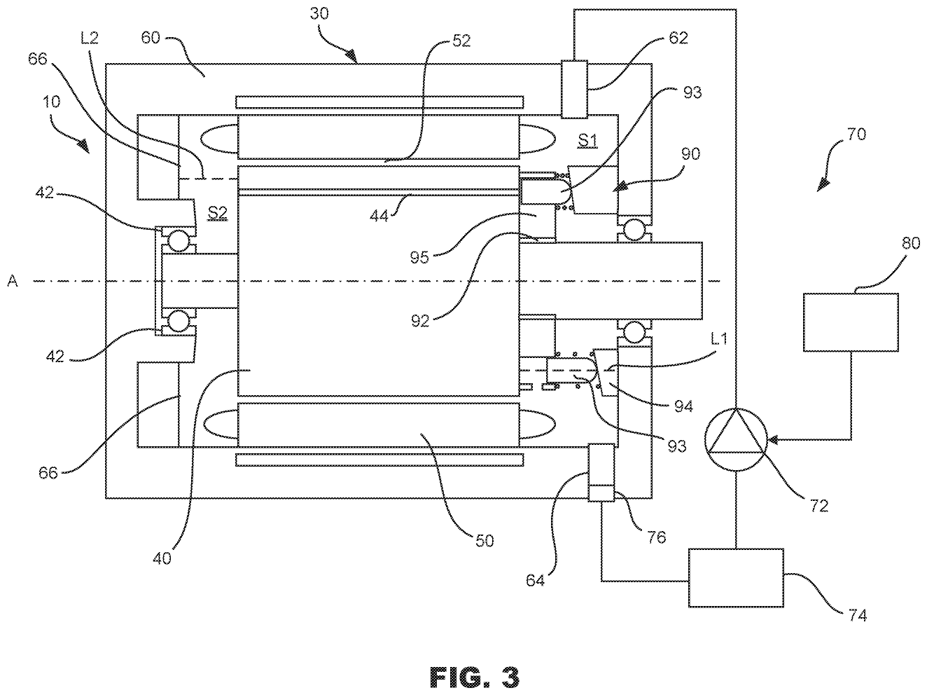

Another example of an electrical machine arrangement 10 is shown in FIG. 3. The electrical machine arrangement 10 is identical to the example described with reference to FIG. 2, except for the channel 44 and the axial flow pump 90. Hence, similar features and their respective technical description will not be repeated.

In the example of FIG. 3 the axial flow pump 90 is in the form of an axial piston pump. The axial piston pump 90 comprises a number of pistons 93 rotatably mounted on the rotor 40 and reciprocally moving due to their interaction with a tilted swash plate 94. When the pistons 93 are at an extended position, which position may be biased by a piston spring, oil is allowed to enter a cylinder block 95. As the pistons 93 rotate, they will reduce the cylinder volume thereby producing an increased oil pressure inside the cylinder block 95. At a position where the pressure is increased, the cylinder block 95 connects to one or more channels 44 extending through the rotor 40 from the first axial side S1 to the opposite axial side S2. Oil will thereby be pumped from the first axial side S1 to the opposite side S2 by means of the axial flow pump 90, and return back to the first axial side S1 through the return oil channel 52.

In order to reduce the rotational mass when there is no need for braking, the cylinder block 95 may be connected to the rotor 40 via a disconnect coupling 92. The disconnect coupling 92 may be actuated in any conventional way, which is known in the art. In a preferred example actuation of the disconnect coupling 92 can be controlled by the control unit 80, such that the axial flow pump 90 is connected and in operation immediately when the feeder pump 72 is started.

It should be noted that the same concept of using a disconnect coupling 92 may also be implemented for the axial flow pump 90 shown in FIG. 2.

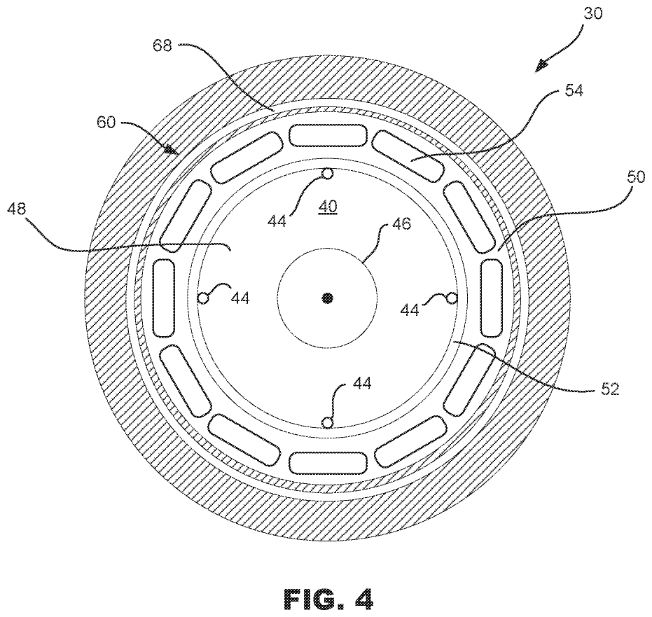

In FIG. 4 the electrical machine 30 is shown in cross section. The housing 60 is here shown as having a cylindrical shape, and a water jacket 68 extends around the circumference to cool down the stator 50. The stator 50 comprises end turns 54 distributed evenly around the stator 50, wherein each end turn 54 corresponds to a stator pole. It should be noted that any suitable number of stator poles could be considered for the electrical machine 30.

The rotor 40 is arranged radially inside the stator 50, wherein a radial space is provided between the rotor 40 and the stator 50 that forms the return oil channel 52.

The rotor 40 comprises an output shaft 46 of a slightly smaller diameter than the main body 48 of the rotor 40. The main body 48 is provided with the one or more oil channels 44. Each oil channel 44 extends from the first axial side of the rotor 40 to the opposite axial side. In the shown example there are four oil channels 44 spaced apart by 90°. The oil channels 44 are arranged immediately inside the outer periphery of the rotor 40.

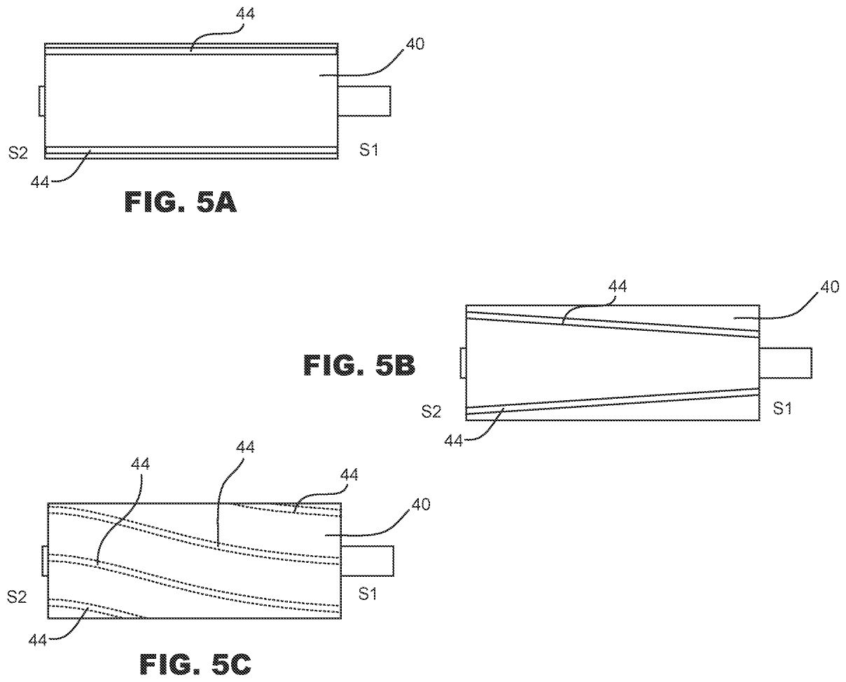

The oil channels 44 may be configured according to various principles, as exemplified in FIGS. 5A-C. Starting in FIG. 5A, the rotor 40 is shown in cross-section. The rotor 40 is provided with a plurality of oil channels 44 arranged at an outer radius (i.e. close to the outer circumference of the rotor 40). The oil channels 44 extend straight through the rotor 40, at a constant radius.

In FIG. 5B another alternative is shown also in cross-section. Here the oil channels 44 extend straight through the rotor 40 but at a varying, in particular an increasing, radius. At the first axial side S1 (i.e. the side being subject to oil filling from the feeder pump) the oil channels 44 are arranged at an inner radius, while their radial position increase along the rotor 40. At the opposite axial side S2 the oil channels 44 are arranged at an outer radius.

In FIG. 5C a further alternative is shown. Here the oil channels 44 are no longer straight, but the circumferential position is varying along the length of the rotor 40. In particular, each oil channel 44 is twisted whereby the length of each oil channel 44 is increased in comparison to straight channels. The twist angle may be small (as shown in FIG. 5C) or significantly larger, resulting in a helical distribution of a channel 44.

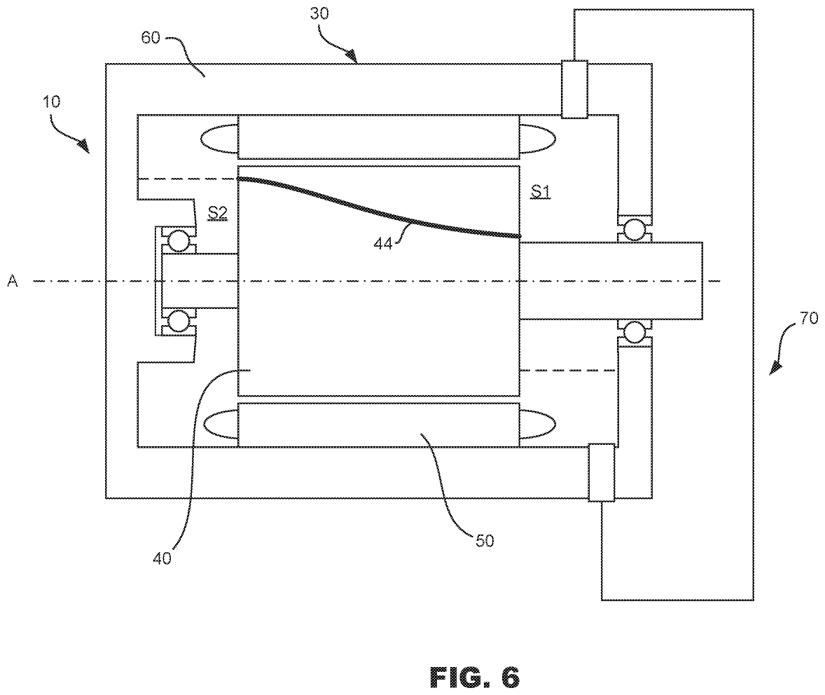

FIG. 6 is another view of an electrical machine arrangement 10, according to an example. The electrical machine arrangement 10 comprises an electrical machine 30 having a rotor 40, a stator 50, and a housing 60 enclosing said rotor 40 and stator 50. The electrical machine arrangement 10 further comprises an oil cooling system 70 connected to the electrical machine 30 and configured to control the oil flow to and from a first axial side S1 of the electrical machine 30. The rotor 40 comprises at least one channel 44 for pumping oil from the first axial side S1 of the electrical machine 30 to a second axial side S2 of the electrical machine 30.

Now turning to FIG. 7 a method 100 for cooling an electrical machine 30 is schematically shown. The method 100 comprises feeding 102 cooling oil to a first axial side S1 of the electrical machine 30, and pumping 104 the cooling oil from the first axial side S1 of the electrical machine 30 to a second, opposite axial side S2 of the electrical machine 30 through at least one channel 40 extending along a rotor 40 of the electrical machine 30. The method 100 further comprises controlling 106 the amount of cooling oil at the first axial side S1 in order to control a retarding effect of the electrical machine 30.

Example 1: An electrical machine arrangement, comprising: an electrical machine 30 having a rotor 40, a stator 50, and a housing 60 enclosing said rotor 40 and stator 50, and an oil cooling system 70 connected to the electrical machine 30 and configured to control the oil flow to and from a first axial side S1 of the electrical machine 30, wherein the rotor 40 comprises at least one channel 44 for pumping oil from the first axial side S1 of the electrical machine 30 to a second axial side S2 of the electrical machine 30.

Example 2: The electrical machine arrangement of Example 1, wherein the oil cooling system 70 comprises a feeder pump 72.

Example 3: The electrical machine arrangement of Example 1 or 2, wherein the feeder pump 72 is arranged remote from the electrical machine 30.

Example 4: The electrical machine arrangement of Example 2 or 3, wherein the oil cooling system 70 further comprises a sump 74 and wherein the feeder pump 72 is configured to pump oil from said sump 74.

Example 5: The electrical machine arrangement of any of Examples 2 to 4, wherein the oil cooling system 70 further comprises an outlet valve 76 configured to control the oil flow out from the first axial side S1 of the electrical machine 30.

Example 6: The electrical machine arrangement of Example 5, wherein the oil cooling system 70 further comprises a control unit 80 configured to control the operation of the feeder pump 72 and/or the outlet valve 76.

Example 7: The electrical machine arrangement of any of Examples 1-6, wherein the electrical machine 30 further comprises an oil return channel 52 arranged in the radial space formed between the rotor 40 and the stator 50.

Example 8: The electrical machine arrangement of any of Examples 1-7, wherein the rotor 40 comprises a plurality of channels 44 for pumping oil from the first axial side S1 of the electrical machine 30 to a second axial side S2 of the electrical machine 30.

Example 9: The electrical machine arrangement of Example 8, wherein the plurality of channels 44 are distributed at an equal angular space around the rotor 40.

Example 10: The electrical machine arrangement of any of Examples 1-9, wherein the at least one channel 44 is arranged at an outer circumference of said rotor 40.

Example 11: The electrical machine arrangement of any of Examples 1-9, wherein the at least one channel 44 is embedded in the rotor 40 and arranged radially inside the maximum rotor radius.

Example 12: The electrical machine arrangement of any of Examples 1-11, wherein the at least one channel 44 extends axially along the entire rotor 40 from the first axial side S1 of the electrical machine 30 to a second axial side S2 of the electrical machine 30.

Example 13: The electrical machine arrangement of any of Examples 1-12, wherein the at least one channel 44 extends along a constant radius.

Example 14: The electrical machine arrangement of any of Examples 1-12, wherein the at least one channel 44 extends from an inner radius at the first axial side S1 of the electrical machine 30 to an outer radius at the second axial side S2 of the electrical machine 30.

Example 15: The electrical machine arrangement of any of Examples 1-14, wherein the at least one channel 44 extends at a constant circumferential angle.

Example 16: The electrical machine arrangement of any of Examples 1-14, wherein the at least one channel 44 extends at a varying circumferential angle.

Example 17: The electrical machine arrangement of any of Examples 1-16, wherein the rotor 40 is provided with an axial flow pump 90 arranged at the first axial side S1 of the electrical machine 30.

Example 18: The electrical machine arrangement of Example 1, wherein the oil cooling system 70 comprises a feeder pump 72, a sump 74, an outlet valve 76, and a control unit 80, wherein the feeder pump 72 is arranged remote from the electrical machine 30 and configured to pump oil from the sump 74, wherein the outlet valve 76 is configured to control the oil flow out from the first axial side S1 of the electrical machine, and wherein the control unit 80 is configured to control the operation of the feeder pump 72 and/or the outlet valve 76, wherein the electrical machine 30 further comprises an oil return channel 52 arranged in the radial space formed between the rotor 40 and the stator 50, wherein the rotor 40 comprises a plurality of channels 44 for pumping oil from the first axial side S1 of the electrical machine 30 to a second axial side S2 of the electrical machine 30, wherein the plurality of channels 44 are distributed at an equal angular space around the rotor 40, wherein the plurality of channels 44 are arranged at an outer circumference of the rotor 44 or embedded in the rotor 40 and arranged radially inside the maximum rotor radius, wherein the plurality of channels 44 extend axially along the entire rotor 40 from the first axial side S1 of the electrical machine 30 to the second axial side S2 of the electrical machine 30, wherein the plurality of channels 44 extend at a constant radius or from an inner radius at the first axial side S1 of the electrical machine 30 to an outer radius at the second axial side S2 of the electrical machine 30, wherein each of the plurality of channels 44 extends at a constant circumferential angle or at a varying circumferential angle, and wherein the rotor 40 is provided with an axial flow pump 90 arranged at the first axial side S1 of the electrical machine 30.

Example 19: A vehicle comprising the electrical machine arrangement 10 according to any of Examples 1-13.

Example 20: A method for cooling an electrical machine, comprising: feeding cooling oil to a first axial side of the electrical machine, pumping the cooling oil from the first axial side of the electrical machine to a second axial side of the electrical machine through at least one channel extending along the rotor, and controlling the amount of cooling oil at the first axial side in order to control a retarding effect of the electrical machine.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. An electrical machine arrangement, comprising: an electrical machine having a rotor, a stator, and a housing enclosing said rotor and stator, and an oil cooling system connected to the electrical machine and configured to control the oil flow to and from a first axial side of the electrical machine, wherein the rotor comprises at least one channel for pumping oil from the first axial side of the electrical machine to a second axial side of the electrical machine.

2. The electrical machine arrangement of claim 1, wherein the oil cooling system comprises a feeder pump.

3. The electrical machine arrangement of claim 2, wherein the feeder pump is arranged remote from the electrical machine.

4. The electrical machine arrangement of claim 2, wherein the oil cooling system further comprises a sump and wherein the feeder pump is configured to pump oil from said sump.

5. The electrical machine arrangement of claim 2, wherein the oil cooling system further comprises an outlet valve configured to control the oil flow out from the first axial side of the electrical machine.

6. The electrical machine arrangement of claim 5, wherein the oil cooling system further comprises a control unit configured to control the operation of the feeder pump and/or the outlet valve.

7. The electrical machine arrangement of claim 1, wherein the electrical machine further comprises an oil return channel arranged in the radial space formed between the rotor and the stator.

8. The electrical machine arrangement of claim 1, wherein the rotor comprises a plurality of channels for pumping oil from the first axial side of the electrical machine to a second axial side of the electrical machine.

9. The electrical machine arrangement of claim 8, wherein the plurality of channels are distributed at an equal angular space around the rotor.

10. The electrical machine arrangement of claim 1, wherein the at least one channel is arranged at an outer circumference of said rotor.

11. The electrical machine arrangement of claim 1, wherein the at least one channel is embedded in the rotor and arranged radially inside the maximum rotor radius.

12. The electrical machine arrangement of claim 1, wherein the at least one channel extends axially along the entire rotor from the first axial side of the electrical machine to a second axial side of the electrical machine.

13. The electrical machine arrangement of claim 1, wherein the at least one channel extends along a constant radius.

14. The electrical machine arrangement of claim 1, wherein the at least one channel extends from an inner radius at the first axial side of the electrical machine to an outer radius at the second axial side of the electrical machine.

15. The electrical machine arrangement of claim 1, wherein the at least one channel extends at a constant circumferential angle.

16. The electrical machine arrangement of claim 1, wherein the at least one channel extends at a varying circumferential angle.

17. The electrical machine arrangement of claim 1, wherein the rotor is provided with an axial flow pump arranged at the first axial side of the electrical machine.

18. The electrical machine arrangement of claim 1, wherein the oil cooling system comprises a feeder pump, a sump, an outlet valve, and a control unit, wherein the feeder pump is arranged remote from the electrical machine and configured to pump oil from the sump, wherein the outlet valve is configured to control the oil flow out from the first axial side of the electrical machine, and wherein the control unit is configured to control the operation of the feeder pump and/or the outlet valve, wherein the electrical machine further comprises an oil return channel arranged in the radial space formed between the rotor and the stator, wherein the rotor comprises a plurality of channels for pumping oil from the first axial side of the electrical machine to a second axial side of the electrical machine, wherein the plurality of channels are distributed at an equal angular space around the rotor, wherein the plurality of channels are arranged at an outer circumference of the rotor or embedded in the rotor and arranged radially inside the maximum rotor radius, wherein the plurality of channels extend axially along the entire rotor from the first axial side of the electrical machine to the second axial side of the electrical machine, wherein the plurality of channels extend at a constant radius or from an inner radius at the first axial side of the electrical machine to an outer radius at the second axial side of the electrical machine, wherein each of the plurality of channels extends at a constant circumferential angle or at a varying circumferential angle, and wherein the rotor is provided with an axial flow pump arranged at the first axial side of the electrical machine.

19. A vehicle comprising the electrical machine arrangement according to claim 1.

20. A method for cooling an electrical machine, comprising: feeding cooling oil to a first axial side of the electrical machine, pumping the cooling oil from the first axial side of the electrical machine to a second axial side of the electrical machine through at least one channel extending along the rotor, and controlling the amount of cooling oil at the first axial side in order to control a retarding effect of the electrical machine.
